(19) United States
(12) Patent Application Publication
(10) Pub. No.: US 2026/0351219 A1
(43) Pub. Date: Nov. 5, 2026

(54) DEVICE, SYSTEM AND METHOD FOR SIMULATING AN EFFECT OF A LIGHT TRANSMITTANCE AFFECTING ELEMENT

(71) Applicant: SHAMIR OPTICAL INDUSTRY LTD., Kibbutz Shamir (IL)

(72) Inventors: Amit TZUR, Kibbutz Shamir (IL); Alon HOVAV, Beit Hillel (IL); Gil LIANNI, Kibbutz Ma'ayan (IL); Alexander SHUR, Haifa (IL); Liron GLESER, Rosh Pina (IL); Uri GREEN

(21) Appl. No.: 19/488,943

(22) PCT Filed: May 30, 2024
(86) PCT No.: PCT/IL2024/050532

§ 371 Date: Dec. 1, 2025

Related U.S. Application Data
(60) Provisional application No. 63/505,541, filed on Jun. 1, 2023.

(51) Int. Cl. G09G 5/02

(52) U.S. Cl. CPC G09G 5/02; G09G 2320/0242; G09G 2320/0666

(57) ABSTRACT

A method of demonstrating an effect of a light transmittance affecting element, which may include, using a computing device operating a processor: for each pixel of a plurality of pixels of an image: based on a transmittance profile of the light transmittance affecting element and a display correlation dataset correlating selected sets of Red, Green, Blue (RGB) values and respective sets of wavelength values of light emitted by a display, converting a set RGB values associated with the respective pixel to a modified set of RGB values, and controlling the display to present the respective pixel based on the modified set of RGB values.

### FIELD OF THE INVENTION

The present invention relates to the field of devices, systems and methods for simulating an effect of a light transmittance affecting element, and more particularly, to automatic devices and methods thereof.

### BACKGROUND OF THE INVENTION

Typically, demonstration of an effect of a light transmittance affecting element of an optical lens involves manual operations and/or processing. For example, an image may be obtained using an optical lens having no light transmittance affecting element and a semitransparent layer may be then manually added to the image to demonstrate the effect of a particular light transmittance affecting element. In another example, two images may be obtained and presented to the user, wherein a first image of the two images may be obtained using an optical lens having no light transmittance affecting element and a second image of the two images may be obtained using an optical lens with the light transmittance affecting element.

### SUMMARY OF THE INVENTION

Embodiments of the present invention may provide a method of demonstrating an effect of a light transmittance affecting element, which may include, using a computing device operating a processor: for each pixel of a plurality of pixels of an image: based on a transmittance profile of the light transmittance affecting element and a display correlation dataset correlating selected sets of Red, Green, Blue (RGB) values and respective sets of wavelength values of light emitted by a display, converting a set RGB values associated with the respective pixel to a modified set of RGB values, and controlling the display to present the respective pixel based on the modified set of RGB values.

The converting may include, for each pixel of the plurality of pixels: based on the display correlation dataset, determining a set of wavelength values that corresponds to the set of RGB values associated with the respective pixel; based on the transmittance profile and the determined set of wavelength values, determining a modified set of wavelength values; and based on the display correlation dataset and the determined modified set of wavelength values, determining the modified set of RGB values.

Based on the transmittance profile and the display correlation dataset, an RGB correlation dataset correlating between selected sets of RGB values and respective modified sets of RGB values may be determined; and for each pixel of the plurality of pixels, based the set of RGB values associated with the respective pixel and the RGB correlation dataset, the modified set of RGB values may be determined.

Determining the RGB correlation dataset may include, for each set of RGB values of the selected sets of RGB values: based on the display correlation dataset, determining a set of wavelength values that corresponds to the respective set of RGB values; based on the transmittance profile and the determined set of wavelength values, determining a modified set of wavelength values; based on the display correlation dataset and the determined modified set of wavelength values, determining the modified set of RGB values; and correlating the respective set of RGB values with the respective modified set of RGB values.

The converting may be further based on a physiological transmittance profile indicating how a human eye transmits light of different wavelengths.

The display correlation dataset may be determined by, for each set of RGB values of the selected of sets of RGB values: controlling the display to present a color represented by the respective set of RGB values; obtaining a measured set of wavelength values of light emitted by the display during presentation of the color represented by the respective set of RGB values; and correlating the obtained set of wavelength values and the respective set of RGB values.

Embodiments of the present invention may provide a computing device for demonstrating an effect of a light transmittance affecting element, which may include: a memory; and a processor configured to, for each pixel of a plurality of pixels of an image: based on a transmittance profile of the light transmittance affecting element and a display correlation dataset correlating selected sets of Red, Green, Blue (RGB) values to respective sets of wavelength values emitted by a display, convert a set RGB values associated with the respective pixel to a modified set of RGB values, and control the display to present the respective pixel based on the modified set of RGB values.

The processor may be configured to, for each pixel of the plurality of pixels: based on the display correlation dataset, determine a set of wavelength values that corresponds to the set of RGB values associated with the respective pixel; based on the transmittance profile and the determined set of wavelength values, determine a modified set of wavelength values; and based on the display correlation dataset and the determined modified set of wavelength values, determine the modified set of RGB values.

The processor may be configured to: based on the transmittance profile and the display correlation dataset, determine an RGB correlation dataset correlating between selected sets of RGB values and respective modified sets of RGB values; and for each pixel of the plurality of pixels, based the set of RGB values associated with the respective pixel and the RGB correlation dataset, determine the modified set of RGB values.

The processor may be configured to, for each set of RGB values of the selected sets of RGB values: based on the display correlation dataset, determine a set of wavelength values that corresponds to the respective set of RGB values; based on the transmittance profile and the determined set of wavelength values, determine a modified set of wavelength values; based on the display correlation dataset and the determined modified set of wavelength values, determine the modified set of RGB values; and correlate the respective set of RGB values with the respective modified set of RGB values.

The processor may convert the set RGB values associated with each pixel of the plurality of pixels of the image to the modified set of RGB values of the respective pixel further based on a physiological transmittance profile indicating how a human eye transmits light of different wavelengths as function of a physiological parameter of the human eye.

The processor may be configured to, for each set of RGB values of the selected of sets of RGB values: control the display to present a color represented by the respective set of RGB values; obtain a measured set of wavelength values of light emitted by the display during presentation of the color represented by the respective set of RGB values; and correlate the obtained set of wavelength values and the respective set of RGB values.

Embodiments of the present invention may provide a method of demonstrating an effect of a light transmittance affecting element, which may include, using a computing device operating a processor: for each pixel of a plurality of pixels of an image: based on a display correlation dataset correlating selected sets of Red, Green, Blue (RGB) values and respective sets of wavelength values of light emitted by a display, determining a set of wavelength values that corresponds to a set of RGB values associated with the respective pixel; based on a transmittance profile of the light transmittance affecting element and the determined set of wavelength values, determining a modified set of wavelength values; based on the display correlation dataset and the determined modified set of wavelength values, determining a modified set of RGB values; and controlling the display to present the respective pixel based on the modified set of RGB values.

Embodiments of the present invention may provide a computing device for demonstrating an effect of a light transmittance affecting element, which may include: a memory; and a processor configured to, for each pixel of a plurality of pixels of an image: based on a display correlation dataset correlating selected sets of Red, Green, Blue (RGB) values and respective sets of wavelength values of light emitted by a display, determine a set of wavelength values that corresponds to a set of RGB values associated with the respective pixel; based on a transmittance profile of the light transmittance affecting element and the determined set of wavelength values, determine a modified set of wavelength values; based on the display correlation dataset and the determined modified set of wavelength values, determine a modified set of RGB values; and control the display to present the respective pixel based on the modified set of RGB values.

Embodiments of the present invention may provide a method of demonstrating an effect of a light transmittance affecting element, which may include, using a computing device operating a processor: determining an RGB correlation dataset by, for each set of RGB values of selected sets of RGB values: based on a display correlation dataset correlating selected sets of Red, Green, Blue (RGB) values and respective sets of wavelength values of light emitted by a display, determining a set of wavelength values that corresponds to the respective set of RGB values, based on a transmittance profile of the light transmittance affecting element and the determined set of wavelength values, determining a modified set of wavelength values, based on the display correlation dataset and the determined modified set of wavelength values, determining the modified set of RGB values, and correlating the respective set of RGB values and the respective modified set of RGB values; and for each pixel of a plurality of pixels of an image: based on a set of RGB values associated with the respective pixel and the RGB correlation dataset, determining the modified set of RGB values, and controlling the display to present the respective pixel based on the modified set of RGB values.

Embodiments of the present invention may provide a computing device for demonstrating an effect of a light transmittance affecting element, which may include: a memory; and a processor configured to: for each set of RGB values of selected sets of RGB values: based on a display correlation dataset correlating selected sets of Red, Green, Blue (RGB) values and respective sets of wavelength values of light emitted by a display, determine a set of wavelength values that corresponds to the respective set of RGB values, based on a transmittance profile of the light transmittance affecting element and the determined set of wavelength values, determine a modified set of wavelength values, based on the display correlation dataset and the determined modified set of wavelength values, determine the modified set of RGB values, and correlate the respective set of RGB values and the respective modified set of RGB values to determine an RGB correlation dataset; and for each pixel of a plurality of pixels of an image: based a set of RGB values associated with the respective pixel and the RGB correlation dataset, determine the modified set of RGB values, and control the display to present the respective pixel based on the modified set of RGB values.

### BRIEF DESCRIPTION OF THE DRAWINGS

For a better understanding of embodiments of the invention and to show how the same can be carried into effect, reference will now be made, purely by way of example, to the accompanying drawings in which like numerals designate corresponding elements or sections throughout. The patent or patent application contains at least one drawing executed in color. Copies of this patent or patent application publication with color drawing(s) will be provided by the Office upon request and payment of the necessary fee. In the accompanying drawings:

FIG. 1 is a block diagram of an exemplary computing device which may be used with embodiments of the present invention;

FIG. 2 is a block diagram of a system including a computing device for demonstrating or simulating of an effect of a light transmittance affecting element, according to some embodiments of the invention;

FIG. 3 is a graph showing a transmittance profile of a light transmittance affecting element, according to some embodiments of the invention;

FIGS. 4A and 4B are illustrations of a first image presented based on original sets of red, green, blue (RGB) values and a second image presented based on a modified sets of RGB values determined based on the transmittance profile of the light transmittance affecting element, respectively, according to some embodiments of the invention;

FIGS. 4C and 4D are schematic illustrations of pixeled representations of a portion of the first image of FIG. 4A and of a portion of the second image of FIG. 4B, respectively, according to some embodiments of the invention;

FIG. 5 is a graph showing a physiological transmittance profile of the human eye;

FIGS. 6A, 6B and 6C are illustrations of a first image presented based on original sets of RGB values, a second image presented based on a first modified sets of RGB values determined based on the physiological transmittance profile, and a third image presented based on a second modified sets of RGB values determined based on the physiological transmittance profile and the transmittance profile of the light transmittance affecting element, respectively, according to some embodiments of the invention;

FIGS. 6D, 6E and 6F are schematic illustrations of pixeled representations of a portion of the first image of FIG. 6A, a portion of the second image of FIG. 6B, and a portion of the third image of FIG. 6C, respectively, according to some embodiments of the invention;

FIG. 7 is a block diagram of a system for determining a display correlation dataset, according to some embodiments of the invention; and

FIG. 8 is a flowchart of a method of demonstrating an effect of a light transmittance affecting element, according to some embodiments of the invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

Embodiments of the present invention may improve demonstration or simulation of an effect of a light transmittance affecting element. The light transmittance affecting element may be an optical filter that may be embedded in an optical lens, a coating that may be applied on a surface of the optical lens and/or any other suitable element or elements that may affect the light transmittance through the light transmittance affecting element and through the optical lens that includes the light transmittance affecting element. Operations for demonstrating or simulating the effect of the light transmittance affecting element may be carried out automatically using a computing device operating a processor. The operations may be performed in real time, for example based on images obtained in real time by a camera and/or based images loaded into or stored in a memory of the computing device.

In operation, an image may be received by the processor of the computing device. The image may include a plurality of pixels. Each pixel of the plurality of pixels may have a set of Red, Green, Blue (RGB) values associated with the respective pixel (e.g., as described hereinbelow).

For each pixel of the plurality of pixels of the image, based on a transmittance profile of the light transmittance affecting element and a display correlation dataset correlating selected sets of RGB values to respective sets of wavelength values emitted by a display, a modified set of RGB values may be determined by the processor. Upon the conversion, the image may be presented by the processor on the display, wherein each pixel of the plurality of pixels of the image may be presented based on the modified set of RGB values determined for the respective pixel. The image presented based on the modified sets of RGB values may demonstrate or simulate the effect of the light transmittance affecting element.

Embodiments of the present invention may allow a user to experience or understand how the light transmittance affecting element such as optical filer and/or coating of the optical lens would affect their visual acuity and/or visual perception, for example before ordering optical lenses including the light transmittance affecting element. Embodiments of the present invention may be used as a research and development tool, for example for assessing and analyzing new light transmittance affecting elements such as optical filters and/or coatings.

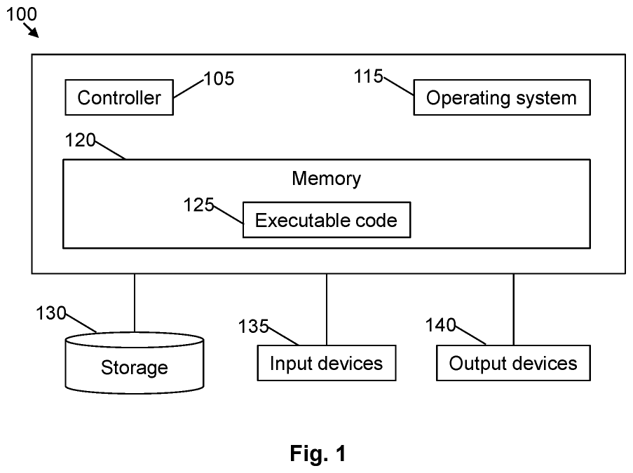

Reference is now made to FIG. 1, which is a block diagram of an exemplary computing device which may be used with embodiments of the present invention.

Computing device 100 may include a controller or processor 105 that may be, for example, a central processing unit processor (CPU), a chip or any suitable computing or computational device, an operating system 115, a memory 120, a storage 130, input devices 135 and output devices 140.

Operating system 115 may be or may include any code segment designed and/or configured to perform tasks involving coordination, scheduling, arbitration, supervising, controlling or otherwise managing operation of computing device 100, for example, scheduling execution of programs. Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different, memory units. Memory 120 may store for example, instructions to carry out a method (e.g., code 125), and/or data such as user responses, interruptions, etc.

Executable code 125 may be any executable code, e.g., an application, a program, a process, task or script. Executable code 125 may be executed by controller 105 possibly under control of operating system 115. In some embodiments, more than one computing device 100 or components of device 100 may be used for multiple functions described herein. For the various modules and functions described herein, one or more computing devices 100 or components of computing device 100 may be used. Devices that include components similar or different to those included in computing device 100 may be used, and may be connected to a network and used as a system. One or more processor(s) 105 may be configured to carry out embodiments of the present invention by for example executing software or code. Storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit. In some embodiments, some of the components shown in FIG. 1 may be omitted.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100, for example, a wired or wireless network interface card (NIC), a modem, printer or facsimile machine, a universal serial bus (USB) device or external hard drive may be included in input devices 135 and/or output devices 140.

Embodiments of the invention may include one or more article(s) (e.g., memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

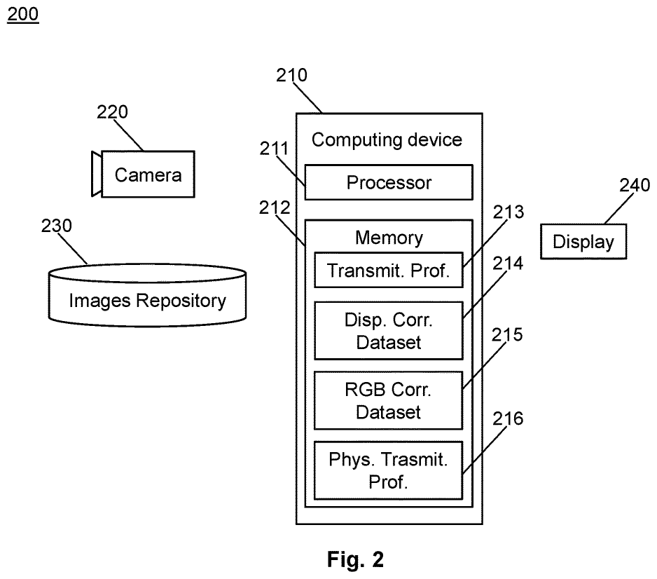

Reference is made to FIG. 2, which is a block diagram of a system 200 including a computing device 210 for demonstrating or simulating of an effect of a light transmittance affecting element, according to some embodiments of the invention.

System 200 may include a computing device 210 (e.g., such as computing device 100 described hereinabove and/or any other suitable computing device). Computing device 210 may include a processor 211. Computing device 210 may include a memory 212.

Processor 211 may receive an image. For example, the image may be obtained by a camera 220. In another example, the image may be stored in an images repository 230. In another example, the image may be stored in memory 212 of computing device 200. The image may include a plurality of pixels. Each pixel of the plurality of pixels may have a set of Red, Green, Blue (RGB) values associated with the respective pixel. For example, each pixel of the plurality of pixels may encode the respective set of RGB values. In another example, the set of RGB values may be associated with the respective pixel of the plurality of pixels by a color look-up table and/or in any other suitable way. In some embodiments, the image may be encoded using color models other than RGB model, such as Hue Saturation Value (HSV) model, Cyan, Magenta, Yellow, Key (CMYK) model and/or any other suitable color model. Since modern displays are typically based on RGB color model, if the received image is encoded using a color model other than RGB model, processor 210 may convert the color model of the image to the RGB model, for example prior to further processing of the image.

For each pixel of the plurality of pixels of the image, based on a transmittance profile 213 of the light transmittance affecting element and a display correlation dataset 214, processor 211 may convert the set of RGB values of the respective pixel to a modified set of the RGB values.

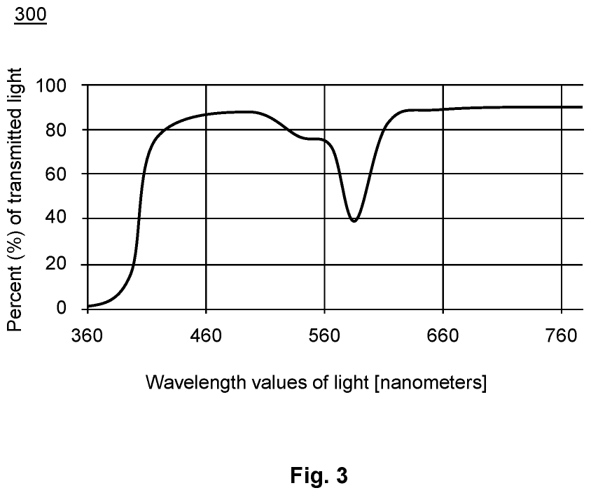

Transmittance profile 213 of the light transmittance affecting element may indicate how the light transmittance affecting element transmits light of different wavelengths therethrough and through the optical lens including the light transmittance affecting element. One example of transmittance profile 213 is described below with respect to FIG. 3. Transmittance profile 213 may be stored for example in memory 212 of computing device 210.

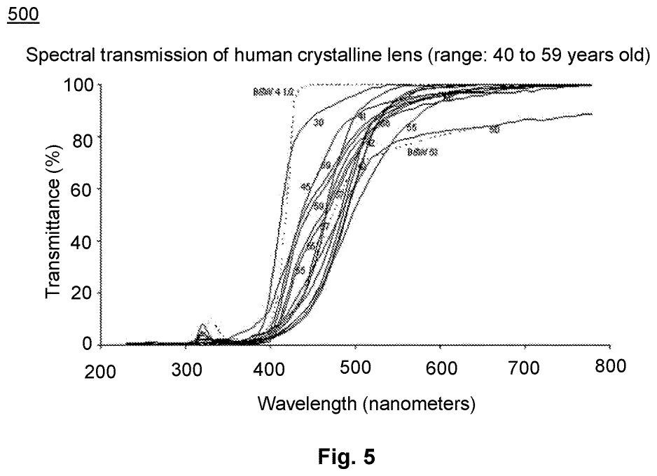

Display correlation dataset 214 may correlate between selected sets of RGB values and their respective sets of wavelength values of light emitted by a display 240. Display correlation dataset 214 may be display-specific. Different configurations of display 240 may require different display correlation datasets 214. For example, display correlation dataset 214 may be determined specifically for display 240 to be used to demonstrate or simulate the effect of the light transmittance affecting element. In one example, display correlation dataset 214 may be determined based on specifications of display 240. In another example, display correlation dataset 214 may be determined based on measurements of sets of wavelength values of light emitted by display 240 during presentation of colors represented by the selected sets of RGB values (e.g., as described below with respect to FIG. 5). Display correlation dataset 214 does not necessarily correlate between all possible sets of RGB values and their respective sets of wavelength values. Instead, display correlation dataset 214 may correlate between selected sets of RGB values to their respective sets of wavelength values while sets of wavelength values that correspond to non-selected sets of RGB values may be interpolated or otherwise estimated at any suitable stage based on the selected sets of RGB values and their respective sets of wavelength values.

In one example of the conversion, for each pixel of the plurality of pixels of the image, processor 211 may: based on display correlation dataset 214, determine a set of wavelength values that corresponds to the set of RGB values of the respective pixel; based on transmittance profile 213 and the determined set of wavelength values, determine a modified set of wavelength values; and based on display correlation dataset 214 and the determined modified set of wavelength values, determine the modified set of RGB values.

In another example of the conversion, for each pixel of the plurality of pixels of the image, processor 211 may: based on a set of RGB values associated with the respective pixel and an RGB correlation dataset 215, determine the modified set of RGB values. RGB correlation dataset 215 may correlate between selected sets of RGB values and their respective modified sets of RGB values. In one example, RGB correlation dataset 215 may be determined by processor 210 and stored for example in memory 212 of computing device 210. In another example, RGB correlation dataset 215 may be predetermined and preloaded into memory 212. RGB correlation dataset 215 may be determined by performing the following operations for each set of RGB values of the selected sets of RGB values: based on display correlation dataset 214, determining a set of wavelength values that corresponds to the respective set of RGB values; based on transmittance profile 213 and the determined set of wavelength values, determining a modified set of wavelength values; based on display correlation dataset 214 and the determined modified set of wavelength values, determining the modified set of RGB values; and correlating the respective set of RGB values with the respective modified set of RGB values. The calculation of RGB correlation dataset 215 is not necessarily based on all possible sets of RGB values. Instead, calculation of RGB correlation dataset 215 may be based on a subset of all possible sets of RGB values and their respective modified sets of RGB values while the modified sets of RGB values that correspond to non-selected sets of RGB values may be interpolated or otherwise estimated at any suitable stage based on the selected sets of RGB values and their respective modified sets of RGB values.

Color models other than RGB model may be converted by processor 211 to sets of wavelength values in a similar way as described hereinabove. For example, if the received image is encoded using a color model other than RGB model, processor 210 may, for each pixel of the plurality of pixels, convert the set of values of the color model associated with the respective pixel to the respective set of wavelength values (e.g., as described hereinabove) and further convert the respective set of wavelength values to the respective modified set of RGB values (e.g., as described hereinabove).

In some embodiments, processor 211 converts the set of RGB values of each pixel of the plurality of pixels of the image to the modified set of the RGB values of the respective pixel further based on a physiological transmittance profile 216 of a human eye. Physiological transmittance profile 216 may indicate how the human eye transmits light of different wavelengths as a function of a physiological parameter of the human or the human eye. For example, the crystalline lens of the human eye may yellow with age, which may reduce the transmittance of the light spectrum by the crystalline lens of the human eye, e.g. especially the transmittance of wavelengths within the range of 400-460 nm. The Table below shows the relative transmittance of light of wavelengths within the range of 400-460 nm as function of age of the human eye:

| Age | Transmittance of wavelengths |
|---|---|
| (years) | 400-460 nm (%) |
| 2 | 75 |
| 10 | 65 |
| 20 | 60 |
| 40 | 55 |
| 60 | 40 |

One example of physiological transmittance profile 216 is described below with respect to FIG. 5. Physiological transmittance profile 216 may be stored for example in memory 212 of computing device 210.

In one example, physiological transmittance profile 216 may be considered in the direct conversion of the set of RGB values to the modified set of RGB values of each pixel of the plurality of pixels of the image. In particular, for each pixel of the plurality of pixels of the image, processor 211 may: based on display correlation dataset 214, determine the set of wavelength values that corresponds to the set of RGB values of the respective pixel; based on transmittance profile 213, physiological transmittance profile 216 and the determined set of wavelength values, determine the modified set of wavelength values; and based on display correlation dataset 214 and the determined modified set of wavelength values, determine the modified set of RGB values.

In another example, physiological transmittance profile 216 may be considered in determination of RGB correlation dataset 215 correlating between selected sets of RGB values and respective modified sets of RGB values. In particular, for each set of RGB values of the selected sets of RGB values, processor 211 may: based on display correlation dataset 214, determine the set of wavelength values that corresponds to the respective set of RGB values; based on transmittance profile 213, physiological transmittance profile 216 and the determined set of wavelength values, determine the modified set of wavelength values; based on display correlation dataset 214 and the determined modified set of wavelength values, determine the modified set of RGB values; and correlate the respective set of RGB values with the respective modified set of RGB values.

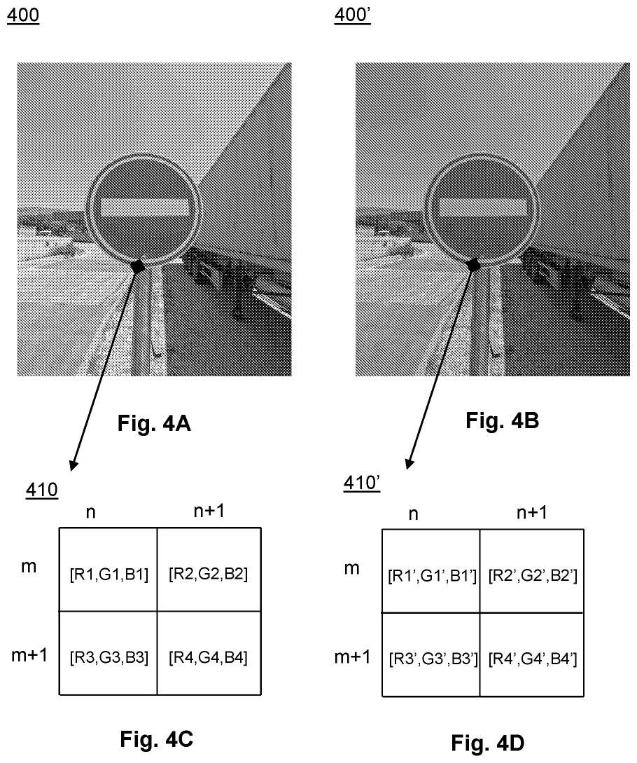

Processor 211 may control display 240 to present each pixel of the plurality of the pixels of the image based on the modified set of RGB values determined for the respective pixel. The image presented on display 240 based on the modified sets of RGB values may demonstrate or simulate the effect of the light transmittance affecting element. In some embodiments, processor 211 may control display 240 to display two images, wherein a first image of the two images may be displayed based on the original sets of RGB values and a second image of the two images may be displayed based on the modified sets of RGB values. The difference between the first image and the second image may, for example, enhance the demonstration of the effect of the light transmittance affecting element. Examples of the first image and the second image are described below with respect to FIGS. 4A, 4B, 4C and 4D.

Processor 211 may perform the operations described hereinabove on a portion of the image. Processor 211 may perform the operations described hereinabove a portion of pixels of the plurality of pixels of the image.

Reference is made to FIG. 3, which is a graph showing a transmittance profile 300 of a light transmittance affecting element, according to some embodiments of the invention.

Transmittance profile 300 may be represented by a curve indicating a percent of light that may pass through the light transmittance affecting element as function of the light's wavelength value. For example, the light transmittance affecting element represented by transmittance profile 300 may transmit about 40% of light having the wavelength value of about 585 nanometers and transmit about 90% of light having the wavelength values of about 600 nanometers and more.

Reference is made to FIGS. 4A and 4B, which are illustrations of a first image 400 presented based on original sets of RGB values and a second image 400′ presented based on the modified sets of RGB values, respectively, according to some embodiments of the invention.

Reference is also made to FIGS. 4C and 4D, which are schematic illustrations of pixeled representations of a portion 410 of first image 400 of FIG. 4A and of a portion 410′ of second image 400′ of FIG. 4B, respectively, according to some embodiments of the invention.

The difference between first image 400 presented based on original sets of RGB values (e.g., as shown in FIGS. 4A and 4C) and second image 400′ presented based on the modified sets of RGB values (e.g., as shown in FIGS. 4B and 4D, wherein the modified sets of RGB values are indicated by “′” symbol in FIG. 4B) may enhance the demonstration of the effect of the light transmittance affecting element and/or allow the user to experience or understand how the light transmittance affecting element such as optical filter and/or coating of the optical lens would affect their visual acuity and/or visual perception.

Reference is made to FIG. 5, which is a graph showing a physiological transmittance profile 500 of the human eye.

In the example of FIG. 5, physiological transmittance profile 500 shows a total spectral transmission of the crystalline lens of the human eye aged between 40 and 59 years, and that of a 30-year-old crystalline lens, reproduced from “Artigas et al., “Spectral Transmission of the Human Crystalline Lens in Adult and Elderly Persons: Color and Total Transmission of Visible Light”, Investigative Ophthalmology & Visual Science June 2012, Vol. 53. Physiological transmittance profile 500 may include one or more curves each indicating the percent of light that may pass through the human eye as function of the light's wavelength value and as function of one or more physiological parameter of the human eye (e.g., such the age of the crystalline lens and/or any other physiological parameter that may affect the transmittance of light through the human eye). Physiological transmittance profile 500 may indicate the percent of light that may pass through the human eye (e.g., transmittance percent) in a specific wavelength range rather than the entire spectrum. In the example of crystalline lens yellowing, physiological transmittance profile 500 may, for example, indicate the percent of light that may pass through the human eye (e.g., transmittance percent) in the wavelength range between 400 to 460 nm, which is the range that is most affected by the crystalline lens yellowing (e.g., as described hereinabove).

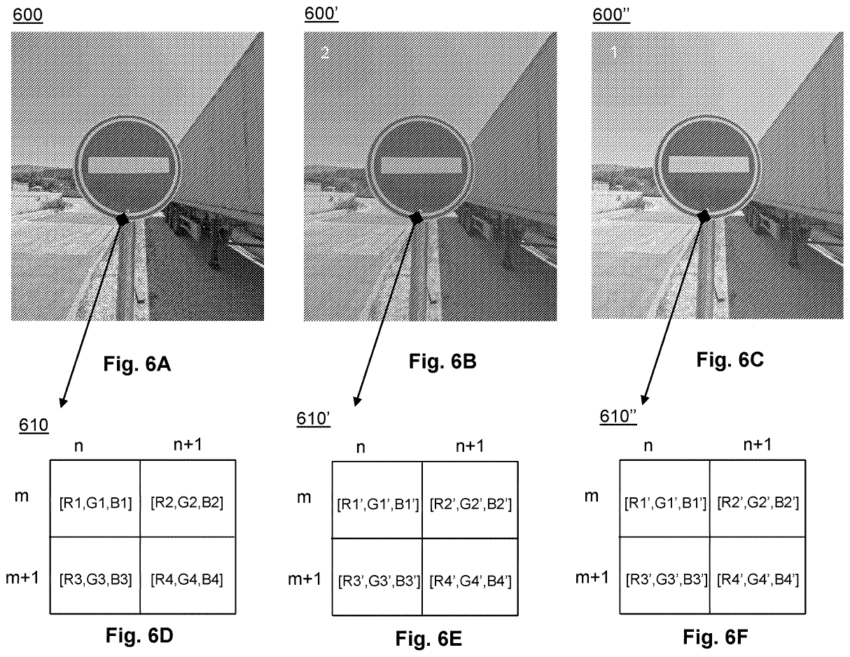

Reference is made to FIGS. 6A, 6B and 6C, which are illustrations of a first image 600 presented based on original sets of RGB values, a second image 600′ presented based on a first modified sets of RGB values determined based on a physiological transmittance profile, and a third image 600″ presented based on a second modified sets of RGB values determined based on the physiological transmittance profile and a transmittance profile of the light transmittance affecting element, respectively, according to some embodiments of the invention.

Reference is also made to FIGS. 6D, 6E and 6F, which are schematic illustrations of pixeled representations of a portion 610 of first image 600 of FIG. 6A, a portion 610′ of second image 600′ of FIG. 6B, and a portion 610″ of third image 600″ of FIG. 6C, respectively, according to some embodiments of the invention.

First image 600 of FIGS. 6A and 6D is presented based on original sets of RGB values.

Second image 600′ of FIGS. 6B and 6E is presented based on the first modified sets of RGB values (wherein the first modified sets of RGB values are indicated by “′” symbol in FIG. 6E) determined based on a physiological transmittance profile (such as profiles 216 and 500 described hereinabove) factoring the crystalline lens yellowing (e.g., in the wavelength range of 400 to 460 nm).

Third image 600″ of FIGS. 6C and 6F is presented based on the second modified sets of RGB values (wherein the second modified sets of RGB values are indicated by “″” symbol in FIG. 6F) determined based on the physiological transmittance profile of FIGS. 6B and 6E and further based on the transmittance profile of the light transmittance affecting element (such as profiles 213 and 300 described hereinabove).

The difference between first image 600 presented based on original sets of RGB values (e.g., as shown in FIGS. 6A and 6D), second image 600′ presented based on the first modified sets of RGB values (e.g., as shown in FIGS. 6B and 6E) and third image 600″ presented based on the second modified sets of RGB values (e.g., as shown in FIGS. 6C and 6F) may enhance the demonstration of the effect of the light transmittance affecting element and the effect of physiological parameters (e.g., such as age-related crystalline lens yellowing as in the example of FIGS. 6B and 6E) and/or allow the user to experience or understand how the light transmittance affecting element such as optical filter and/or coating of the optical lens would affect their visual acuity and/or visual perception.

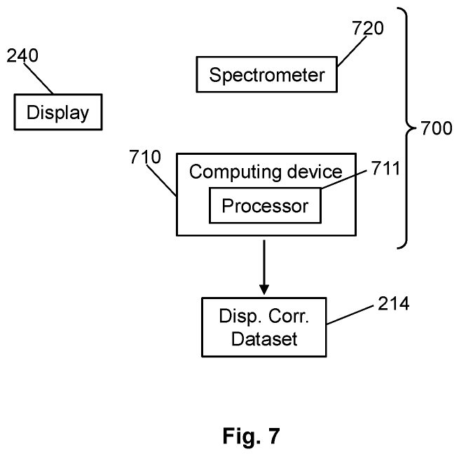

Reference is made to FIG. 7, which is a block diagram of a system 700 for determining display correlation dataset 214, according to some embodiments of the invention.

System 700 may include a computing device 710 (e.g., such as computing device 100 and/or computing device 210 described hereinabove) operating a processor 711, and a spectrometer 720. As described hereinabove, display correlation dataset 214 may be display-specific and should be determined for display 240 to be used to demonstrate the effect of the light transmittance affecting element.

In order to determine display correlation dataset 214, processor 711 of computing device 710 may select sets of RGB values; and for each set of RGB values of the selected set of RGB values processor 711 may: control display 240 to present a color represented by the respective set of RGB values; obtain from spectrometer 240 a set of wavelength values of light emitted by display 240 during presentation of the color represented by the respective set of RGB values (e.g., measure or otherwise obtain the measured set of wavelength values); and correlate the obtained set of wavelength values with the respective set of RGB values. As described hereinabove, the selected sets of RGB values does not necessarily include all possible sets of RGB values and their respective sets of wavelength values. Instead, the sets of wavelength values that correspond to non-selected sets of RGB values may be interpolated or otherwise estimated at any suitable stage based on the selected sets of RGB values and their respective sets of wavelength values. The estimation may, for example, rely on known properties of display 240 (e.g., in some displays the light emittance of the RGB values may be additive; other known properties of display 240 may be used for estimation).

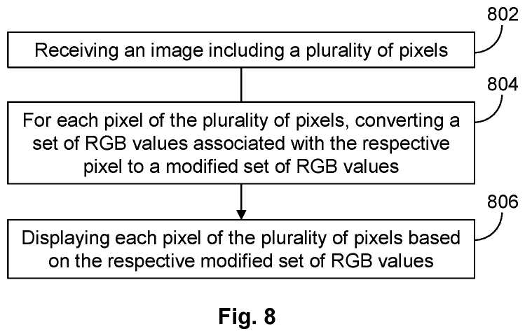

Reference is made to FIG. 8, which is a flowchart of a method of demonstrating an effect of a light transmittance affecting element, according to some embodiments of the invention.

The operations described herein with respect to FIG. 6 may be performed using a computing device operating a processor, for example using computing device 100 and/or computing device 210 described hereinabove and/or using any other suitable computing device.

In operation 802, an image may be received by a processor of the computing device. The image may include a plurality of pixels. Each pixel of the plurality of pixels may have a set of RGB values associated with the respective pixel (e.g., as described hereinabove). If the received image is encoded using a color model other than RGB model, the color model of the image may be converted by the processor to the RGB model prior to further processing of the image.

In operation 804, for each pixel of the plurality of pixels of the image, based on a transmittance profile of the light transmittance affecting element (e.g., such as transmittance profile 213 and/or transmittance profile 300 described hereinabove) and a display correlation dataset (e.g., such as display correlation dataset 214 described hereinabove), the set of RGB values associated with the respective pixel may be converted by the processor to a modified set of the RGB values.

The transmittance profile of the light transmittance affecting element may indicate how the light transmittance affecting element transmits light of different wavelengths therethrough and through the optical lens including the light transmittance affecting element. The display correlation dataset may correlate between selected sets of RGB values and their respective sets of wavelength values of light emitted by the display. The display correlation dataset may be display-specific and may be determined specifically for the display to be used to demonstrate or simulate the effect of the light transmittance affecting element. The display correlation dataset may be determined based on specifications of the display and/or based on measurements of sets of wavelength values of light emitted by the display during presentation of colors represented by the selected sets of RGB values (e.g., as described hereinabove).

In one example, the conversion may include, for each pixel of the plurality of pixels of the image: based on the display correlation dataset, determining by the processor a set of wavelength values that corresponds to the set of RGB values of the respective pixel; based on the transmittance profile and the determined set of wavelength values, determining by the processor a modified set of wavelength values; and based on the display correlation dataset and the determined modified set of wavelength values, determining by the processor the modified set of RGB values.

In another example, the conversion may include, for each pixel of the plurality of pixels of the image: based on a set of RGB values associated with the respective pixel and an RGB correlation dataset (e.g., such as RGB correlation dataset 215 described hereinabove), determine the modified set of RGB values. The RGB correlation set may correlate between selected sets of RGB values and respective modified sets of RGB values (e.g., as described hereinabove). The RGB correlation dataset may be determined as described hereinabove.

In some embodiments, the conversion may be further based on a physiological transmittance profile of a human eye (e.g., such as physiological profiles 216, 500 described hereinabove). In one example, the physiological transmittance profile may be considered in the direct conversion of the set of RGB values to the modified set of RGB values of each pixel of the plurality of pixels of the image (e.g., as described hereinabove). In another example, the physiological transmittance profile may be considered in determination of the RGB correlation dataset correlating between selected sets of RGB values and respective modified sets of RGB values (e.g., as described hereinabove).

In operation 806, the display may be controlled by the processor to present each pixel of the plurality of the pixels of the image based on the modified set of RGB values determined for the respective pixel (e.g., as described hereinabove). The image presented based on the modified sets of RGB values may demonstrate or simulate the effect of the light transmittance affecting element (e.g., as described hereinabove).

The operations described hereinabove may be performed on a portion of the image. The operations described hereinabove may be performed on a portion of pixels of the plurality of pixels of the image.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

Although embodiments of the invention are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

1. A method of demonstrating an effect of a light transmittance affecting element, the method comprising, using a computing device operating a processor:
for each pixel of a plurality of pixels of an image:
based on a transmittance profile of the light transmittance affecting element and a display correlation dataset correlating selected sets of Red, Green, Blue (RGB) values and respective sets of wavelength values of light emitted by a display, converting a set RGB values associated with the respective pixel to a modified set of RGB values, and
controlling the display to present the respective pixel based on the modified set of RGB values.

2. The method of claim 1, wherein converting comprises, for each pixel of the plurality of pixels:
based on the display correlation dataset, determining a set of wavelength values that corresponds to the set of RGB values associated with the respective pixel;
based on the transmittance profile and the determined set of wavelength values, determining a modified set of wavelength values; and
based on the display correlation dataset and the determined modified set of wavelength values, determining the modified set of RGB values.

3. The method of claim 1, comprising:
based on the transmittance profile and the display correlation dataset, determining an RGB correlation dataset correlating between selected sets of RGB values and respective modified sets of RGB values; and
for each pixel of the plurality of pixels, based the set of RGB values associated with the respective pixel and the RGB correlation dataset, determining the modified set of RGB values.

4. The method of claim 3, wherein determining the RGB correlation dataset comprises, for each set of RGB values of the selected sets of RGB values:
based on the display correlation dataset, determining a set of wavelength values that corresponds to the respective set of RGB values;
based on the transmittance profile and the determined set of wavelength values, determining a modified set of wavelength values;
based on the display correlation dataset and the determined modified set of wavelength values, determining the modified set of RGB values; and
correlating the respective set of RGB values with the respective modified set of RGB values.

5. The method of claim 1, wherein converting is further based on a physiological transmittance profile indicating how a human eye transmits light of different wavelengths as function of a physiological parameter of the human eye.

6. The method of any one of claims 1-5, comprising determining the display correlation dataset by, for each set of RGB values of the selected of sets of RGB values:
controlling the display to present a color represented by the respective set of RGB values;
obtaining a measured set of wavelength values of light emitted by the display during presentation of the color represented by the respective set of RGB values; and
correlating the obtained set of wavelength values and the respective set of RGB values.

7. A computing device for demonstrating an effect of a light transmittance affecting element, the computing device comprising:
a memory; and
a processor configured to, for each pixel of a plurality of pixels of an image:
based on a transmittance profile of the light transmittance affecting element and a display correlation dataset correlating selected sets of Red, Green, Blue (RGB) values to respective sets of wavelength values emitted by a display, convert a set RGB values associated with the respective pixel to a modified set of RGB values, and
control the display to present the respective pixel based on the modified set of RGB values.

8. The computing device of claim 7, wherein the processor is configured to, for each pixel of the plurality of pixels:
based on the display correlation dataset, determine a set of wavelength values that corresponds to the set of RGB values associated with the respective pixel;
based on the transmittance profile and the determined set of wavelength values, determine a modified set of wavelength values; and
based on the display correlation dataset and the determined modified set of wavelength values, determine the modified set of RGB values.

9. The computing device of claim 7, wherein the processor is configured to:
based on the transmittance profile and the display correlation dataset, determine an RGB correlation dataset correlating between selected sets of RGB values and respective modified sets of RGB values; and
for each pixel of the plurality of pixels, based the set of RGB values associated with the respective pixel and the RGB correlation dataset, determine the modified set of RGB values.

10. The computing device of claim 9, wherein the processor is configured to, for each set of RGB values of the selected sets of RGB values:
based on the display correlation dataset, determine a set of wavelength values that corresponds to the respective set of RGB values;
based on the transmittance profile and the determined set of wavelength values, determine a modified set of wavelength values;
based on the display correlation dataset and the determined modified set of wavelength values, determine the modified set of RGB values; and
correlate the respective set of RGB values with the respective modified set of RGB values.

11. The computing device of claim 7, wherein the processor is configured to convert the set RGB values associated with each pixel of the plurality of pixels of the image to the modified set of RGB values of the respective pixel further based on a physiological transmittance profile indicating how a human eye transmits light of different wavelengths as function of a physiological parameter of the human eye.

12. The computing device of any one of claims 7-11, wherein the processor is configured to, for each set of RGB values of the selected of sets of RGB values:
control the display to present a color represented by the respective set of RGB values;
obtain a measured set of wavelength values of light emitted by the display during presentation of the color represented by the respective set of RGB values; and
correlate the obtained set of wavelength values and the respective set of RGB values.

13. A method of demonstrating an effect of a light transmittance affecting element, the method comprising, using a computing device operating a processor:
for each pixel of a plurality of pixels of an image:
based on a display correlation dataset correlating selected sets of Red, Green, Blue (RGB) values and respective sets of wavelength values of light emitted by a display, determining a set of wavelength values that corresponds to a set of RGB values associated with the respective pixel;
based on a transmittance profile of the light transmittance affecting element and the determined set of wavelength values, determining a modified set of wavelength values;
based on the display correlation dataset and the determined modified set of wavelength values, determining a modified set of RGB values; and
controlling the display to present the respective pixel based on the modified set of RGB values.

14. A computing device for demonstrating an effect of a light transmittance affecting element, the computing device comprising:
a memory; and
a processor configured to, for each pixel of a plurality of pixels of an image:
based on a display correlation dataset correlating selected sets of Red, Green, Blue (RGB) values and respective sets of wavelength values of light emitted by a display, determine a set of wavelength values that corresponds to a set of RGB values associated with the respective pixel;
based on a transmittance profile of the light transmittance affecting element and the determined set of wavelength values, determine a modified set of wavelength values;
based on the display correlation dataset and the determined modified set of wavelength values, determine a modified set of RGB values; and
control the display to present the respective pixel based on the modified set of RGB values.

15. A method of demonstrating an effect of a light transmittance affecting element, the method comprising, using a computing device operating a processor:
determining an RGB correlation dataset by, for each set of RGB values of selected sets of RGB values:
based on a display correlation dataset correlating selected sets of Red, Green, Blue (RGB) values and respective sets of wavelength values of light emitted by a display, determining a set of wavelength values that corresponds to the respective set of RGB values,
based on a transmittance profile of the light transmittance affecting element and the determined set of wavelength values, determining a modified set of wavelength values,
based on the display correlation dataset and the determined modified set of wavelength values, determining the modified set of RGB values, and
correlating the respective set of RGB values and the respective modified set of RGB values; and
for each pixel of a plurality of pixels of an image:
based on a set of RGB values associated with the respective pixel and the RGB correlation dataset, determining the modified set of RGB values, and
controlling the display to present the respective pixel based on the modified set of RGB values.

16. A computing device for demonstrating an effect of a light transmittance affecting element, the computing device comprising:
a memory; and
a processor configured to:
for each set of RGB values of selected sets of RGB values:
based on a display correlation dataset correlating selected sets of Red, Green, Blue (RGB) values and respective sets of wavelength values of light emitted by a display, determine a set of wavelength values that corresponds to the respective set of RGB values,
based on a transmittance profile of the light transmittance affecting element and the determined set of wavelength values, determine a modified set of wavelength values,
based on the display correlation dataset and the determined modified set of wavelength values, determine the modified set of RGB values, and
correlate the respective set of RGB values and the respective modified set of RGB values to determine an RGB correlation dataset; and
for each pixel of a plurality of pixels of an image:
based a set of RGB values associated with the respective pixel and the RGB correlation dataset, determine the modified set of RGB values, and
control the display to present the respective pixel based on the modified set of RGB values.
